(19) United States
(12) Patent Application Publication
(10) Pub. No.: US 2009/0228147 A1
(43) Pub. Date: Sep. 10, 2009

(54) Apparatus and Method for Controlling Air Conditioner

(76) Inventors: Sun-Kyoung Lim, Seoul (KR); Dai-Hyun Kim, Gyeonggi-Do (KR); Hag-Wone Kim, Chungcheongnam-Do (KR)

Correspondence Address: MCKENNA LONG & ALDRIDGE LLP, 1900 K STREET, NW, WASHINGTON, DC, 20006, US

(21) Appl. No.: 11/989,754

(22) PCT Filed: Oct. 24, 2006
(86) PCT No.: PCT/KR2006/004338

§ 371 Date: Jan. 31, 2008

(30) Foreign Application Priority Data
Nov. 24, 2005 (KR) 10-2005-0113163

(51) Int. Cl. G05B 15/00; H02P 27/00

(52) U.S. Cl. 700/275; 318/400.3

(57) ABSTRACT

An apparatus and method for controlling an air conditioner capable of reducing a fabrication cost by using one high-speed microcomputer and one port-ex-tension microcomputer, enhancing a reliability thereof by reducing a data communication amount between the microcomputers, and implementing a simple circuit construction. The apparatus for controlling an air conditioner comprising: a converter for converting an alternating current voltage (ACV) into a direct current voltage (DCV), and boosting the DCV; a smoothening unit for smoothening the DCV from the converter; an inverter for converting the smoothened DCV into an ACV; and a motor, comprises: a supplementary microcomputer for controlling a valve for controlling a refrigerant flow inside a pipe of the air conditioner and a relay for controlling a current flow by receiving a control signal; and a main microcomputer for entirely controlling the air conditioner with the real-time controlling unit of the air conditioner and the supplementary microcomputer.

### TECHNICAL FIELD

The present invention relates to an apparatus and method for controlling an air conditioner, and more particularly, to a microcomputer of an apparatus for controlling an air conditioner.

### BACKGROUND ART

Generally, a prior art air conditioner is provided with two microcomputers so as to separately control a valve, a fan, a compressor, a power supply unit, etc.

Hereinafter, a prior art apparatus for controlling an air conditioner will be explained with reference to FIG. 1.

FIG. 1 shows an apparatus for controlling an air conditioner in accordance with the prior art.

As shown in FIG. 1, the prior art apparatus for controlling an air conditioner comprises a converter 200 consisting of a rectifying unit 210, an active filter 220, and a smoothening capacitor C, for converting a commercial alternating current (AC) power into a direct current (DC); inverters 300 and 330 for converting the DC converted by the converter 200 into an AC, and supplying the converted AC to a compressor-driving motor 100 and a fan-driving motor 110; inverter controllers 310 and 340 for driving the compressor-driving motor 100 and the fan-driving motor 100 by controlling the inverters 300 and 330; a first microcomputer 360 for controlling position detectors 320 and 350 that detect a position of each pole of the compressor-driving motor 100 and the fan-driving motor 110; and a second microcomputer 280 for controlling an active filter controller 240 that controls the active filter 220, electrical equipment controlling switches 250 (such as relays and valves), a temperature sensor 260, an indoor unit 270, and the first microcomputer 360.

The rectifying unit 210 rectifies an AC voltage inputted from a commercial power. The active filter 220 composed of a reactor L and a switching device Q converts a phase of the inputted AC into a sine waveform of an inputted voltage. The smoothening capacitor C smoothens the output voltage from the active filter 220 into a DC voltage. The smoothened DC voltage is supplied to the inverter 300 for supplying a voltage to the compressor-driving motor 100, and the inverter 330 for supplying a voltage to the fan-driving motor 110.

The active filter controller 240 controls a gate driving unit 23 for driving the switching device Q of the active filter 220, thereby controlling the active filter 220.

The first microcomputer 360 controls the compressor-driving motor 100, and the fan-driving motor 110. The second microcomputer 280 indirectly controls the compressor-driving motor 100 and the fan-driving motor 110 by controlling the first microcomputer 360. Also, the second microcomputer 280 controls the active filter 220 for supplying power to the compressor-driving motor 100 and the fan-driving motor 110, the electrical equipment controlling switches 250, the temperature sensor 260, the indoor unit 270, etc.

The prior art apparatus for controlling an air conditioner has been disclosed in the U.S. Pat. No. 6,397,611 B1.

However, the prior art apparatus for controlling an air conditioner has the following problems.

First, since each high-speed microcomputer that can process data with a high speed has to be implemented as the first microcomputer 360 and the second microcomputer 280, a fabrication cost for the apparatus is increased.

Second, since a data communication amount between the first microcomputer 360 and the second microcomputer 280 is increased, a reliability of the apparatus for controlling an air conditioner is degraded and a complicated circuit is implemented.

### DISCLOSURE OF THE INVENTION

Therefore, an object of the present invention is to provide an apparatus and method for controlling an air conditioner capable of reducing a fabrication cost by using one high-speed microcomputer and one port-extension microcomputer, capable of enhancing a reliability thereof by reducing a data communication amount between the microcomputers, and capable of implementing a simple circuit construction.

To achieve these and other advantages and in accordance with the purpose of the present invention, as embodied and broadly described herein, there is provided an apparatus for controlling an air conditioner comprising: a converter for converting an alternating current (AC) voltage into a direct current (DC) voltage, and boosting the DC voltage; a smoothening unit for smoothening the DC voltage from the converter; an inverter for converting the smoothened DC voltage into an AC voltage; and a motor, the apparatus comprising: a supplementary microcomputer for controlling a valve and a relay by receiving a control signal, the valve for controlling a refrigerant flow inside a pipe of the air conditioner, and the relay for controlling a current flow; and a main microcomputer for entirely controlling the air conditioner with including a real-time controlling unit of the air conditioner and the supplementary microcomputer.

To achieve these and other advantages and in accordance with the purpose of the present invention, as embodied and broadly described herein, there is also provided a method for controlling an air conditioner comprising: a converter for converting an alternating current (AC) voltage into a direct current (DC) voltage, and boosting the DC voltage; a smoothening unit for smoothening the DC voltage from the converter; an inverter for converting the smoothened DC voltage into an AC voltage; and a motor, the method comprising: detecting a current driving state of the air conditioner; performing a supplementary control process for controlling a refrigerant flow inside a pipe of the air conditioner, and a current flow according to the detected driving state by receiving a control signal; and performing a main control process for entirely controlling the air conditioner with including a real-time controlling unit of the air conditioner and the supplementary microcomputer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an apparatus for controlling an air conditioner in accordance with the prior art;

FIG. 2 is an apparatus for controlling an air conditioner according to the present invention; and

FIG. 3 is a flowchart showing a method for controlling an air conditioner according to the present invention.

### MODES FOR CARRYING OUT THE PREFERRED EMBODIMENTS

Reference will now be made in detail to the preferred embodiments of the present invention, examples of which are illustrated in the accompanying drawings.

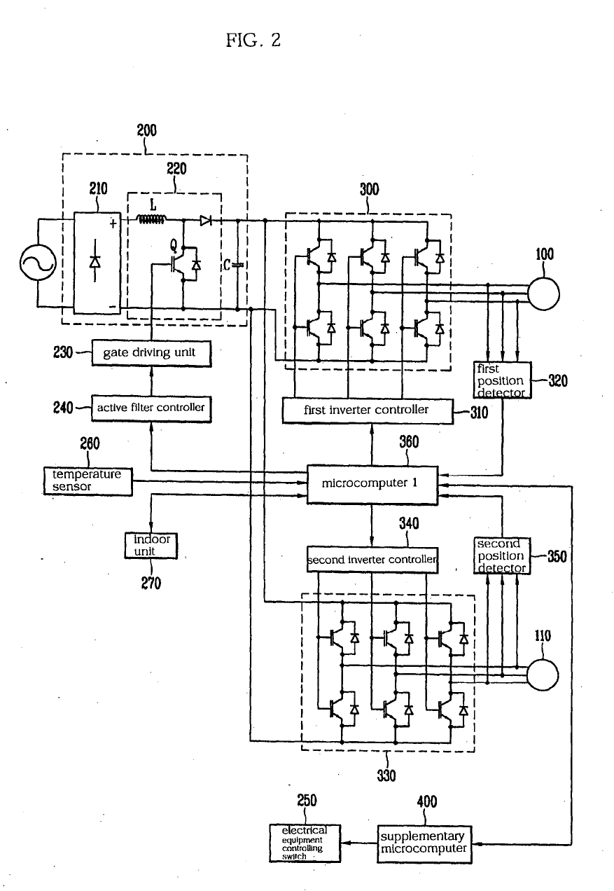

Hereinafter, with reference to FIG. 2, will be explained an apparatus and method for controlling an air conditioner capable of reducing a fabrication cost by using one high-speed microcomputer and one port-extension microcomputer, capable of enhancing a reliability thereof by reducing a data communication amount between the microcomputers, and capable of implementing a simple circuit construction.

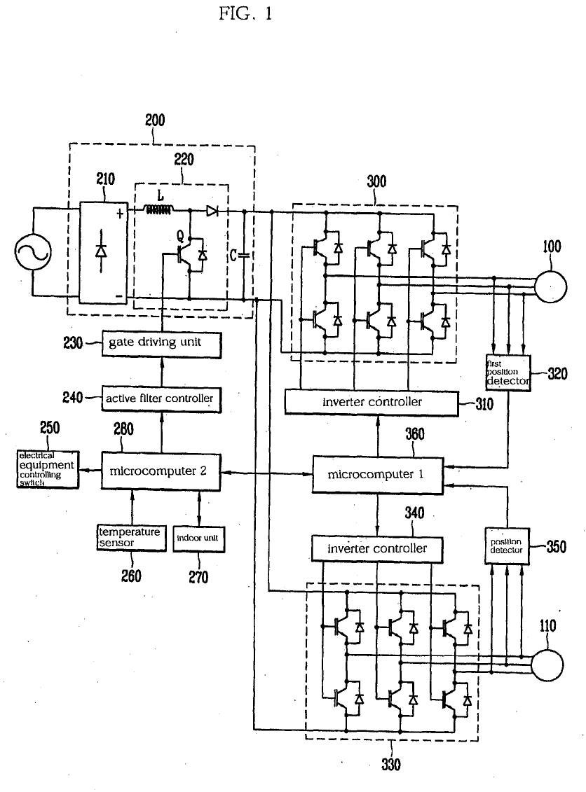

The same reference numerals as those of FIG. 1 will be given to the same parts of FIG. 2 as those of FIG. 1.

FIG. 2 is an apparatus for controlling an air conditioner according to the present invention.

As shown in FIG. 2, an apparatus for controlling an air conditioner comprising: a converter 200 for converting an alternating current (AC) voltage into a direct current (DC) voltage, and boosting the DC voltage; a smoothening unit C for smoothening the DC voltage from the converter 200; inverters 300 and 330 for converting the smoothened DC voltage into an AC voltage; and motors 100 and 110, the apparatus comprises: a supplementary microcomputer 400 for controlling a valve and a relay by receiving a control signal, the valve for controlling a refrigerant flow inside a pipe of the air conditioner, and the relay for controlling a current flow; and a main microcomputer 360 for entirely controlling the air conditioner with including a real-time controlling unit of the air conditioner and the supplementary microcomputer 400.

The real-time controlling unit comprises: a converter for converting an input AC into an input AC voltage of a sine waveform, converting the AC voltage into a DC voltage, and boosting the converted DC voltage; converter controllers 230 and 240 for controlling the converter 200 according to a control signal; a compressor-driving motor 100 for driving a compressor; a first position detector 320 for detecting a position of a pole of the compressor-driving motor; a fan-driving motor 110 for driving a fan; a second position detector 350 for detecting a position of a pole of the fan-driving motor; inverters 300 and 340 for converting the smoothened DC voltage into an AC voltage; and an inverter controller for controlling the inverter according to a control signal so that the converted AC voltage can be supplied to the compressor-driving motor and the fan-driving motor.

The real-time controlling unit further comprises a temperature sensor 260, and an indoor unit 270 for supplying cool air to an indoor room.

The converter controller comprises a gate driving unit 230 for driving a switch that opens and closes a path of an input power supplied to the smoothening unit C, and an active filter controller 240 for generating a switching signal supplied to the gate driving unit.

The main microcomputer 360 is implemented as a high-speed microcomputer, and the supplementary microcomputer is implemented as a port-extension microcomputer 400.

The rectifying unit 210, the active filter 220, the smoothening capacitor C, and the active filter controller 240 have the same structure and operation as those of the prior art, and thus detailed explanation thereof will be omitted.

The main microcomputer and the supplementary microcomputer will be explained as follows.

The main microcomputer is implemented as a high-speed microcomputer, and entirely controls the air conditioner with including the real-time controlling units and the supplementary microcomputer 400 that require a fast response characteristic, the real-time controlling units including the converter 200, the converter controllers 230 and 240, the first and second inverters 300 and 330, the first and second inverter controllers 310 and 340, the temperature sensor 260, the indoor unit 270, the motors 100 and 110, etc. The main microcomputer controls the air conditioner except for the electrical equipment controlling switches 250 that require no real-time control. The supplementary microcomputer 400 is implemented as a port-extension microcomputer, and controls the electrical equipment controlling switches 250 including each relay and each valve which do not require the real-time control.

In the present invention, an expensive high-speed microcomputer serves as the main microcomputer, thereby performing a real-time control. Also, a cheap port-extension microcomputer serves as the supplementary microcomputer, thereby performing a non real-time control. Accordingly, the expensive high-speed microcomputers need not be used in two.

Accordingly, a data communication amount between the microcomputers 360 and 400 is decreased, thereby enhancing a reliability of the apparatus.

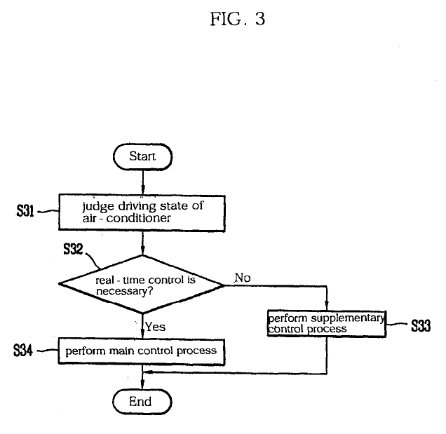

FIG. 3 is a flowchart showing a method for controlling an air conditioner according to the present invention.

As shown in FIG. 3, the method for controlling an air conditioner comprising: a converter for converting an alternating current (AC) voltage into a direct current (DC) voltage, and boosting the DC voltage; a smoothening unit for smoothening the DC voltage from the converter; an inverter for converting the smoothened DC voltage into an AC voltage; and a motor, the method comprises: detecting a current driving state of the air conditioner (S31); performing a supplementary control process for controlling a refrigerant flow inside a pipe of the air conditioner, and a current flow according to the detected driving state by receiving a control signal (S32, S33); and performing a main control process for entirely controlling the air conditioner with including a real-time controlling unit of the air conditioner and the supplementary microcomputer (S32, S34).

The main control process S34 comprises: converting an input AC into an input AC voltage of a sine waveform, converting the AC voltage into a DC voltage, and boosting the converted DC voltage; first-position detecting for detecting a position of a pole of a compressor-driving motor; second-position detecting for detecting a position of a pole of a fan-driving motor; and converting the smoothened DC voltage into an AC voltage according to the detected first and second positions.

The main control process further comprises: detecting each temperature of an indoor room and a compressor valve; and controlling the indoor unit so that cool air can be supplied to the indoor room.

The converting an input AC voltage and boosting comprises: generating a switching signal to drive a converter; and opening and closing a path of an input power supplied to the smoothening unit according to the generated switching signal.

In the main control process (S34), the air conditioner is entirely controlled by the high-speed microcomputer. In the supplementary control process, a refrigerant flow and a current flow inside the air conditioner are controlled by the port-extension microcomputer.

As aforementioned, in the present invention, one expensive high-speed microcomputer and one cheap port-extension microcomputer are used, thereby reducing a fabrication cost of the apparatus for controlling an air conditioner. Furthermore, since the high-speed microcomputer performs a real-time control requiring a fast response characteristic and the port-extension microcomputer controls the relay or the valve requiring no real-time control. Accordingly, a data communication amount between the microcomputers is decreased thus to enhance a reliability of the apparatus.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for controlling an air conditioner comprising:
a converter for converting an alternating current (AC) voltage into a direct current (DC) voltage, and boosting the DC voltage;
a smoothening unit for smoothening the DC voltage from the converter;
an inverter for converting the smoothened DC voltage into an AC voltage; and
a motor, the apparatus comprising:
a supplementary microcomputer for controlling a valve and a relay by receiving a control signal, the valve for controlling a refrigerant flow inside a pipe of the air conditioner, and the relay for controlling a current flow; and
a main microcomputer for entirely controlling the air conditioner with including a real-time controlling unit of the air conditioner and the supplementary microcomputer.

2. The apparatus of claim 1, wherein the real-time controlling unit comprises:
a converter for converting an input AC into an input AC voltage of a sine waveform, converting the AC voltage into a DC voltage, and boosting the converted DC voltage;
a converter controller for controlling the converter according to a control signal;
a compressor-driving motor for driving a compressor;
a first position detector for detecting a position of a pole of the compressor-driving motor;
a fan-driving motor for driving a fan;
a second position detector for detecting a position of a pole of the fan-driving motor;
an inverter for converting the smoothened DC voltage into an AC voltage according to the detected first and second positions; and
an inverter controller for controlling the inverter according to a control signal so that the converted AC voltage be supplied to the compressor-driving motor and the fan-driving motor.

3. The apparatus of claim 2, further comprising:
a temperature sensor for detecting each temperature of an indoor room and a compressor valve; and
an indoor unit for supplying cool air to an indoor room.

4. The apparatus of claim 2, wherein the converter controller comprises:
a gate driving unit for driving a switch that opens and closes a path of an input power supplied to the smoothening unit; and
an active filter controller for generating a switching signal supplied to the gate driving unit.

5. The apparatus of claim 1, wherein the main microcomputer is implemented as a high-speed microcomputer.

6. The apparatus of claim 1, wherein the supplementary microcomputer is implemented as a port-extension microcomputer.

7. A method for controlling an air conditioner comprising:
a converter for converting an alternating current (AC) voltage into a direct current (DC) voltage, and boosting the DC voltage;
a smoothening unit for smoothening the DC voltage from the converter;
an inverter for converting the smoothened DC voltage into an AC voltage; and
a motor, the method comprising:
detecting a current driving state of the air conditioner;
performing a supplementary control process for controlling a refrigerant flow inside a pipe of the air conditioner, and a current flow according to the detected driving state by receiving a control signal; and
performing a main control process for entirely controlling the air conditioner with including a real-time controlling unit of the air conditioner and the supplementary microcomputer.

8. The method of claim 7, wherein the main control process comprises:
converting an input AC into an input AC voltage of a sine waveform, converting the AC voltage into a DC voltage, and boosting the converted DC voltage;
first-position detecting for detecting a position of a pole of a compressor-driving motor;
second-position detecting for detecting a position of a pole of a fan-driving motor; and
converting the smoothened DC voltage into an AC voltage according to the detected first and second positions.

9. The method of claim 8, wherein the main control process further comprises:
detecting each temperature of an indoor room and a compressor valve; and
controlling the indoor unit so that cool air be supplied to the indoor room.

10. The method of claim 8, wherein the converting and boosting comprises:
generating a switching signal to drive a converter; and
opening and closing a path of an input power supplied to the smoothening unit according to the generated switching signal.

11. The method of claim 7, wherein in the main control process, the air conditioner is entirely controlled by the high-speed microcomputer.

12. The method of claim 7, wherein in the supplementary control process, a refrigerant flow and a current flow in the air conditioner are controlled by the port-extension microcomputer.
